(19) United States
(12) Patent Application Publication
(10) Pub. No.: US 2025/0132822 A1
(43) Pub. Date: Apr. 24, 2025

(54) LOWER ORBIT SATELLITE TRACKING

(71) Applicant: Viasat, Inc., Carlsbad, CA (US)

(72) Inventor: Aaron J. Mendelsohn, Dana Point, CA (US)

(21) Appl. No.: 18/682,381

(22) PCT Filed: Aug. 20, 2021
(86) PCT No.: PCT/US2021/047003

§ 371 Date: Feb. 8, 2024

(51) Int. Cl. H04B 7/185; H04B 7/195

(52) U.S. Cl. CPC H04B 7/18547; H04B 7/18519; H04B 7/195

(57) ABSTRACT

Methods, systems, and devices for satellite operations are described. Positioning data for non-geo stationary satellites may be received from the non-geo stationary satellites via one or more satellites in orbits that are higher than the orbits of the non-geostationary satellites. Based on the positioning data, trajectories may be calculated for the non-geostationary satellites. Based on the trajectories calculated for a set of non-geostationary satellites, a distance between the set of the non-geostationary satellites may be predicted to come within a threshold distance and an alert that the distance between the set of non-geostationary satellites is predicted to come within a threshold distance may be communicated to the one or more operators of the set of non-geostationary satellites.

### CROSS REFERENCE

The present Application for Patent is a 371 national phase filing for International Patent Application No. PCT/US2021/047003 by MENDELSOHN, entitled “LOWER ORBIT SATELLITE TRACKING” filed Aug. 20, 2021, assigned to the assignee hereof, and expressly incorporated by reference in its entirety herein.

### BACKGROUND

The following relates generally to satellite operations, including tracking satellites.

Satellites may be placed into geosynchronous equatorial orbits (which may also be referred to as geosynchronous orbits or geostationary orbits) and non-geosynchronous equatorial orbits (which may also be referred to as non-geosynchronous orbits or non-geostationary orbits), where geosynchronous equatorial orbits may be higher than non-geosynchronous equatorial orbits. A larger quantity of satellites may be deployed in non-geosynchronous equatorial orbits than geosynchronous equatorial orbits—e.g., due to the decreased costs of placing a satellite into a non-geosynchronous equatorial orbit, improvement in latency parameters, positioning granularity, mapping resolution, etc. Due to their increased quantity, satellites in non-geosynchronous equatorial orbits may be at a greater risk of colliding with other satellites in non-geosynchronous equatorial orbits.

### SUMMARY

The described techniques relate to improved methods, systems, devices, and apparatuses that support satellite operations. Positioning data for non-geostationary satellites may be received from the non-geostationary satellites via one or more satellites in orbits that are higher than the orbits of the non-geostationary satellites. Based on the positioning data, trajectories may be calculated for the non-geostationary satellites. Based on the trajectories calculated for a set of non-geostationary satellites, a distance between the set of the non-geostationary satellites may be predicted to come within a threshold distance and an alert that the distance between the set of non-geostationary satellites is predicted to come within a threshold distance may be communicated to the one or more operators of the set of non-geostationary satellites.

### BRIEF DESCRIPTION OF THE DRAWINGS

FIG. 1 shows an example of geosynchronous equatorial orbit (GEO) satellites and non-GEO satellites orbiting the earth in accordance with examples described herein.

FIG. 2 shows an example of a satellite subsystem including one or more satellite networks, where the satellite subsystem supports lower orbit satellite tracking in accordance with examples described herein.

FIG. 3 shows an example of a collision detection system that supports lower orbit satellite tracking in accordance with examples described herein.

FIG. 4 shows an example of a non-GEO satellite that supports lower orbit satellite tracking in accordance with examples described herein.

FIG. 5 shows an example of a ground station that supports lower orbit satellite tracking in accordance with examples described herein.

FIGS. 6 through 8 show examples of sets of operations for lower orbit satellite tracking in accordance with examples described herein.

FIG. 9 shows a flowchart illustrating a method that supports lower orbit satellite tracking in accordance with examples described herein.

### DETAILED DESCRIPTION

Satellites may be launched into geosynchronous equatorial orbits (GEOs) and non-geosynchronous equatorial orbits (non-GEOs). In some examples, a large quantity of satellites (e.g., tens of thousands) may be deployed into non-GEOs, and techniques for identifying potential near misses or collisions between satellites deployed in non-GEOs may be used to prevent collisions between satellites. To identify the potential near misses or collisions, ground-based stations may use radar to measure the locations of various space objects, including non-GEO satellites. The locations of the various space objects measured at different tracking stations may be used to predict orbits of the various space objects.

Although ground-based radar techniques may accurately determine a current location of space objects, the ability of ground-based radar-based techniques to continuously track orbits of space objects may be limited. For example, a ground system used to determine a location of space objects may include a small quantity of ground stations (e.g., tens of ground stations). Thus, a quantity of measurements taken by the ground system for a particular space object may be limited—e.g., less than ten measurements may be taken for a space object throughout a single orbital period. The ground system may use the limited set of measurements and orbit prediction techniques to predict a portion of the orbit positioned between ground stations, and thus, perturbations in an orbit of a space object that occur in between ground stations may be missed. Also, given recent plans for deploying massive satellite constellations into non-GEO orbits, an ability to generate real-time information for orbits of non-GEO satellites may become increasingly important—e.g., as near misses and collisions between non-GEO satellite may become more likely.

To obtain near continuous tracking of non-GEO satellites in non-GEOs, a set of GEO satellites may be used to track the orbits of the non-GEO satellites. In some examples, the GEO satellites may be communications satellites, broadband satellites, data satellites, or satellites dedicated to detecting collisions between non-GEO satellites. As described herein, each GEO satellite may maintain near continuous contact with non-GEO satellites within a coverage area of a GEO satellite. In some examples, a large quantity of the deployed non-GEO satellites may be within a coverage area of a GEO satellite at any instant of time—e.g., around twenty percent of the deployed non-GEO satellites may be within a coverage area of a GEO satellite at any instant of time. Accordingly, a small quantity of GEO satellites (e.g., less than five) may be in contact with a large percentage (e.g., greater than ninety percent) of the deployed non-GEO satellites at any instant of time Thus, a set of GEO satellites may be used to receive and relay, to one or more ground stations, near real-time positioning data (or at least an increased quantity of positioning data relative to ground-based techniques) for a large percentage of deployed non-GEO satellites.

In some examples, positioning data for non-GEO satellites may be obtained at one or more ground stations via a set of GEO satellites. That is, the set of GEO satellites may be used to relay positioning data received from non-GEO satellites to the one or more ground stations. Trajectories for the non-GEO satellites may be calculated (e.g., at the ground stations) based on the obtained positioning data. Based on calculating the trajectories, one or more predictions that one or more sets of non-GEO satellites may come within a threshold distance of one another may be obtained. One prediction may indicate that a first non-GEO satellite will come within a threshold distance (e.g., within 1000 meters) of a second non-GEO satellite based on a first trajectory calculated for the first non-GEO satellite and a second trajectory calculated for the second non-GEO satellite. An alert that a distance between the first non-GEO satellite and the second non-GEO satellite is predicted to be less than a threshold distance may be communicated—e.g., to the operators of the first non-GEO satellite and the second non-GEO satellite.

By using GEO satellites for near-continuous monitoring of the orbits of non-GEO satellites, the trajectories of the non-GEO satellites may be determined with increased accuracy and the ability to detect near-misses and/or potential collisions may be improved relative to using ground systems. Also, by using near-continuous monitoring of the non-GEO satellites, real-time and accurate alerts may be sent to operators of the satellites informing them of the detected near-misses and potential collisions, enabling the operators of the non-GEO satellites to take earlier action relative to using ground systems.

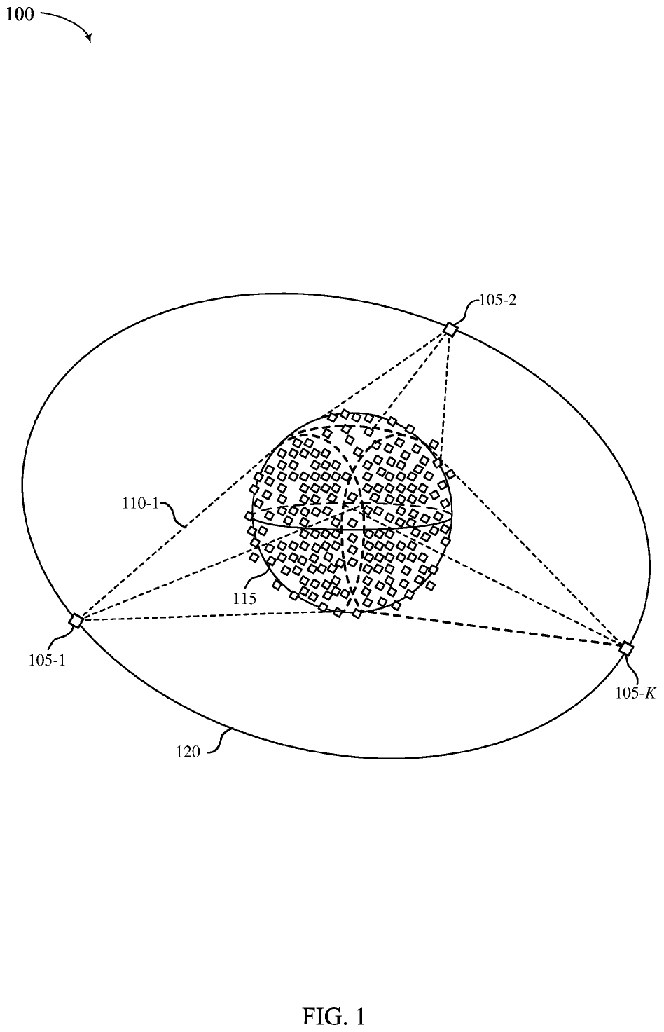

FIG. 1 shows an example of GEO satellites and non-GEO satellites orbiting the earth in accordance with examples described herein.

Constellation diagram 100 may depict geosynchronous equatorial orbit 120 for a set of GEO satellites 105 as well as non-GEO satellites 115 orbiting the earth in orbits that are closer to the earth than geosynchronous equatorial orbit 120—e.g., non-geosynchronous equatorial orbits.

Satellites may be launched into different orbits—e.g., a GEO or a non-GEO. A satellite in a GEO may be referred to as a GEO satellite 105. A satellite in a non-GEO may be referred to as a non-GEO satellite 115 (or may also be referred to as a non-geostationary satellite). Non-GEOs may include medium earth orbits (MEOs), low earth orbits (LEOs), equatorial low earth orbit (ELEO), and the like. A satellite in a MEO may be referred to as a MEO satellite, a satellite in a LEO may be referred to as a LEO satellite, and so on. A GEO satellite 105 may orbit the earth at a speed that matches the rotational speed of the earth, and thus, a GEO satellite 105 may remain in a single location relative to a point on the earth throughout the GEO. A LEO satellite may orbit the earth at a speed (e.g., relative to the ground) that exceeds the rotational speed of the earth, and thus, a location of a LEO satellite relative to a point on the earth may change as the LEO satellite travels through the LEO. LEO satellites may be launched with low inclination (e.g., ELEOs) or high inclination (e.g., polar orbits) to provide different types of coverage and revisit times for given regions of the earth. A EO satellite may also orbit the earth at a speed that exceeds the rotational speed of the earth but may be at a higher altitude than a LEO satellite. A highly elliptical orbit (HEO) satellite may orbit the earth in an elliptical pattern where the satellite moves closer to and farther from the earth throughout the HEO.

In some examples, a GEO satellite 105 may cover a large geographic area (e.g., approximately a third of the surface of the earth) relative to a geographic area covered by a non-GEO satellite 115. For example, first GEO satellite 105-1 may cover an area of the earth within first coverage area 110-1. In some examples, a small quantity of GEO satellites 105 (e.g., less than five) may cover a significant portion (e.g., greater than 90%) of the surface of the earth. A GEO satellite 105 may also be capable of relaying signals for a large quantity of non-GEO satellites 115 (e.g., thousands, tens of thousands, hundreds of thousands) that are within a coverage area 110 of the GEO satellite 105. Similarly, a small quantity of GEO satellites 105 may be used to continuously relay signals for a significant portion (e.g., greater than 90%) of non-GEO satellites 115 that are deployed in non-GEO orbits.

GEO satellites 105 may be more complex and more expensive than non-GEO satellites 115. Additionally, placing GEO satellites 105 into orbit may be more costly than placing non-GEO satellites 115 into orbit, and a number of orbital slots for GEOs may be limited. Thus, a higher quantity of non-GEO satellites 115 may be deployed than GEO satellites 105. Given the high quantity of non-GEO satellites 115 that may be deployed in non-GEO orbits, techniques for identifying potential near misses or collisions between non-GEO satellites may be used. One technique for identifying potential near misses or collisions may include using tracking stations at the surface of the earth. The ground-based tracking stations may use radar-based techniques to measure the locations of various space objects, including non-GEO satellites 115. The locations measured at different ground-based tracking stations may be used to predict orbits of the various space objects.

Although ground-based radar techniques may accurately determine a current location of space objects, the ability of ground-based radar-based techniques to continuously track orbits of space objects may be limited. For example, a ground system used to determine a location of space objects may include a small quantity of ground stations (e.g., tens of ground stations). Thus, a quantity of measurements taken by the ground system for a particular space object may be limited—e.g., less than ten measurements may be taken for a space object throughout an orbital period. The ground system may use the limited set of measurements and orbit prediction techniques to predict a portion of the orbit positioned between ground stations, and thus, perturbations in an orbit of a space object that occur in between ground stations may be missed. Also, given recent plans for deploying massive satellite constellations into non-GEO orbits, an ability to generate real-time information for orbits of non-GEO satellites may become increasingly important—e.g., as near misses and collisions between non-GEO satellite may become more likely.

To obtain near continuous tracking of non-GEO satellites 115 in non-GEOs, a set of GEO satellites 105 may be used to track the orbits of the non-GEO satellites 115. In some examples, the GEO satellites may be communications satellites, broadband satellites, data satellites, or satellites dedicated to detecting collisions between non-GEO satellites. As described herein, each GEO satellite 105 may maintain near continuous contact with non-GEO satellites 115 within a coverage area 110 of a GEO satellite 105. In some examples, a large quantity of the deployed non-GEO satellites 115 may be within a coverage area 110 of a GEO satellite 105 at any instant of time—e.g., around twenty percent of the deployed non-GEO satellites 115 may be within a coverage area of a GEO satellite 105 at any instant of time. Accordingly, a small quantity of GEO satellites 105 (e.g., less than five) may be in contact with a large percentage (e.g., greater than ninety percent) of the deployed non-GEO satellites 115 at any instant of time Thus, a set of GEO satellites 105 may be used to receive and relay, to one or more ground stations, near real-time positioning data (or at least an increased quantity of positioning data relative to ground-based techniques) for a large percentage of deployed non-GEO satellites 115.

In some examples, positioning data for non-GEO satellites 115 may be obtained at one or more ground stations via a set of GEO satellites 105. That is, the set of GEO satellites 105 may be used to relay positioning data received from non-GEO satellites 115 to the one or more ground stations. Trajectories for the non-GEO satellites 115 may be calculated (e.g., at the ground stations) based on the obtained positioning data. Based on calculating the trajectories, one or more predictions that one or more sets of non-GEO satellites 115 may come within a threshold distance of one another may be obtained. One prediction may indicate that a first non-GEO satellite 115 will come within a threshold distance (e.g., within 1000 meters) of a second non-GEO satellite 115 based on a first trajectory calculated for the first non-GEO satellite 115 and a second trajectory calculated for the second non-GEO satellite 115. An alert that a distance between the first non-GEO satellite 115 and the second non-GEO satellite 115 is predicted to be less than a threshold distance may be communicated—e.g., to the operators of the first non-GEO satellite 115 and the second non-GEO satellite.

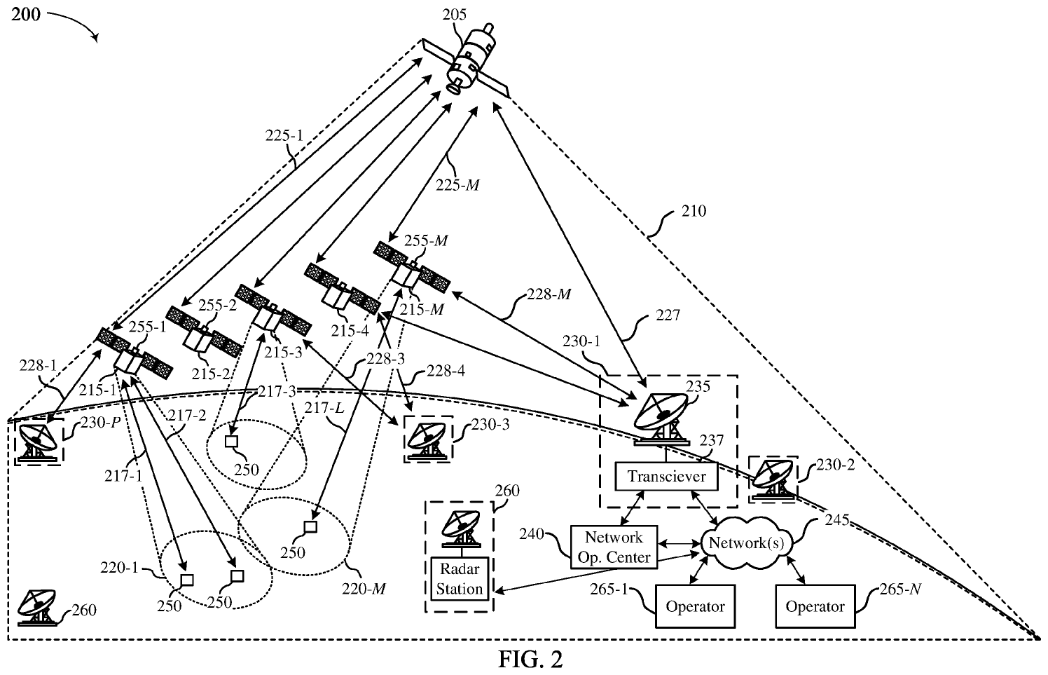

FIG. 2 shows an example of a satellite subsystem including one or more satellite networks, where the satellite subsystem supports lower orbit satellite tracking in accordance with examples described herein.

Satellite subsystem 200 depicts GEO satellite 205, non-GEO satellites 215, ground stations 230 (which may also be referred to as gateways), network operations center 240, user terminals 250, one or more networks 245, one or more radar stations 260, as well as channels and/or connections between the different networks and devices.

GEO satellite 205 and non-GEO satellites 215 may be respective examples of a GEO satellite and a non-GEO satellite described with reference to FIG. 1. GEO coverage area 210 of GEO satellite 205 may include non-GEO satellites 215 and ground stations 230. In some examples, GEO satellite 205 serves terminals within coverage area 210 using multiple beams, where time and frequency resources may be reused in the different beams. In each beam, a set of terminals (e.g., user terminals 250) within a beam may be allocated multiplexed sets of time and frequency resources. In some examples, each beam may support multiple carriers over which communications may be scheduled to one or more terminals. In some examples, handover procedures are used to maintain uninterrupted communications with a terminal when a terminal transitions from the coverage area of one beam to the coverage area of a new beam. After being handed over to a new beam, a terminal may be allocated a new set of time and frequency resources in the new beam to receive communications.

In some examples, communication links 225 may be formed between GEO satellite 205 and non-GEO satellites 215 within GEO coverage area 210. In some examples, communication links 225 are network-based connections established between non-GEO satellites 215 and GEO satellite 205—e.g., using network management signaling. In some examples, communication links 225 are signal paths (e.g., one way signal paths) from a non-GEO satellite 215 to GEO satellite 205 Communication links 225 may be associated with the transmission of signals between GEO satellite 205 and non-GEO satellites 215. In some examples, a terminal installed on a non-GEO satellite 215 may include a transmitter 255 and establish a communication link 225 with GEO satellite 205. In some examples, to establish the communication link 225, the terminal may identify itself based on transmitting, via GEO satellite 205, subscription information to an operator of a satellite communications network that includes GEO satellite 205. Network operations center 240 may receive the subscription information and authenticate the terminal. Based on authenticating the terminal, network operations center 240 may allocate, to the non-GEO satellite 215, resources of a beam for the communication of positioning information. Additionally, first connection 227 may be established between GEO satellite 205 and first ground station 230-1. In some examples, multiple connections are established between GEO satellite 205 and multiple ground stations, including first ground station 230-1.

Non-GEO satellites 215 may be configured to perform different functions/to achieve different objectives. In some examples, one or more of the non-GEO satellites 215 (e.g., second non-GEO satellite 215-2, fourth non-GEO satellite 215-4, or both) may be configured for imaging, sensing, or surveillance operations. In some examples, one or more of non-GEO satellites 215 (e.g., first non-GEO satellite 215-1, third non-GEO satellite 215-3, and Mth non-GEO satellite 215-) may be configured for communication operations. The non-GEO satellites 215 configured for communications may be used to communicate with user terminals 250 located within respective non-GEO coverage areas 220 via user connections 217. In some examples, the non-GEO satellites 215 may communicate directly with ground stations 230 via second connections 228. In other examples, the non-GEO satellites 215 may communicate indirectly with ground stations 230 via GEO satellite 205. In some examples, the non-GEO satellites 215 may communicate directly with ground stations 230 and indirectly with ground stations 230 via GEO satellite 205.

One or more of the non-GEO satellites 215 (e.g., first non-GEO satellite 215-1 and Mth non-GEO satellite 215-A) may be in a same constellation as GEO satellite 205 (e.g., managed by a same operator and configured to complete a common objective). For example, GEO satellite 205, first non-GEO satellite 215-1, and Mth non-GEO satellite 215-M may be a part of a communications network, where GEO satellite 205 may be used to relay communications between ground stations (e.g., first ground station 230-1), first non-GEO satellite 215-1, and Mth non-GEO satellite 215-M.

In some examples, one or more of the non-GEO satellites 215 (e.g., second non-GEO satellite 215-2, third non-GEO satellite 215-3) may be in a different constellation than GEO satellite 205 (e.g., managed by different operators or configured to complete different objectives). For example, second non-GEO satellite 215-2 may be an imaging satellite while GEO satellite 205 may be a communications satellite. In such cases, second non-GEO satellite 215-2 may not exchange signaling associated with its objective (e.g., imaging signaling) with GEO satellite 205. In another example, third non-GEO satellite 215-3 may be a communications satellite that is managed by a different operator than GEO satellite 205. In another example, GEO satellite 205 may be a commercial broadband satellite and may communicate directly with user terminals 250—e.g., without the assistance of non-GEO satellites 215.

First ground station 230-1 may be configured to receive signals transmitted from GEO satellite 205, non-GEO satellites 215, or both. First ground station 230-1 may include antenna 235 and transceiver 237. In some examples, first ground station 230-1, GEO satellite 205, and one or more of non-GEO satellites 215 (e.g., first non-GEO satellite 215-1 and Mth non-GEO satellite 215-Al) may be included in a same satellite network. In such cases, communications between one or more networks 245 and user terminals 250 may be communicated using first ground station 230-1, GEO satellite 205, and non-GEO satellites 215 in some examples, communications between one or more networks 245 and user terminals 250 may be communicated without using GEO satellite 205. In some examples, ground station 230 is included in a satellite communications network. In such cases, first ground station 230-1 may be referred to as an access node terminal and may provide a connection to one or more communication networks (e.g., a cellular network, telephone network, or both), data networks (e.g., the Internet, private networks, or both), or both. First ground station 230-1 may be coupled with other ground stations 230, network operations center 240, and one or more networks 245. In some examples, ground station 230 may be included in a collision detection network.

Network operations center 240 may be or include at least one of a network control center, a satellite and ground station command center, or a central processing center. In some examples, network operations center 240 provides an interface between one or more networks 245 (e.g., the Internet, other public data networks, private data networks, government networks, etc.) and a satellite network that includes ground station 230, GEO satellite 205, and in some examples one or more of non-GEO satellites 215. In some examples, one or more networks 245 can be used to reach operators 265. For example, one or more networks 245 may be connected to command centers for the operators 265. Operators 265 may own and manage the operation of different satellites included in satellite subsystem 200. For example, first operator 265-1 may own and manage the operation of GEO satellite 205, first non-GEO satellite 215-1, fourth non-GEO satellite 215-4, and Mth non-GEO satellite 215-M. And Nth operator 265-N may own and manage the operation of third non-GEO satellite 215-3.

Radar station 260 may be a ground-based station that uses radar to determine a position of space objects (e.g., non-GEO satellites 215). Radar station 260 may be included in a radar network that includes a set of radar stations that are distributed across the surface of the earth, where measurements taken by the set of radar stations may be used to calculate trajectories of the space objects. In some examples, the radar network including radar station 260 is a government network (e.g., the North American Aerospace Defense Command (NORAD)).

As described herein, non-GEO satellites 215 may come within a threshold distance of one another that puts the non-GEO satellites 215 at risk of collision within one another. As also described herein, ground-based techniques for tracking and predicting trajectories of non-GEO satellites 115 may collect insufficient data to accurately predict trajectories of the non-GEO satellites 115 between measurement sites and, thus, may fail to predict/miss perturbations in trajectories of the non-GEO satellites 115 that occur between measurement sites. Accordingly, ground-based techniques for tracking and predicting trajectories of the non-GEO satellites 115 may miss potential collision events between non-GEO satellites 115.

To obtain near continuous tracking of non-GEO satellites 215 (and, in some examples, other space objects deployed into non-GEOs), non-GEO satellites 215 may be configured to transmit (e.g., periodically) positioning information to GEO satellite 205, and GEO satellite 205 may be configured to forward or relay the positioning information to one or more ground stations, such as first ground station 230-1. In some examples, each non-GEO satellite 215 may include a transmitter 255 that is used to transmit, to GEO satellite 205 via a communication link 225, positioning data for a non-GEO satellite 215 coupled with the transmitter 255. In some examples, the transmitter 255 is included in a terminal included on a GEO satellite 205, where the terminal may have a subscription to access a first satellite communications network that includes GEO satellite 205, first non-GEO satellite 215-1, Mth non-GEO satellite 215-M, first ground station 230-1, and Pth ground station 230-P. The terminal may also have a transceiver that enables the reception and transmission of communications with the satellite communications network. In some examples, one or more of the user terminals 250 served by one or more of the non-GEO satellites 215 may also have a subscription to access the first satellite communications network. In other examples, a user terminal 250 may have a subscription to access a different satellite communications network than a terminal included on a non-GEO satellite 215, where the non-GEO satellite 215 is used to serve the user terminal 250—e.g., the different satellite communications network may include third non-GEO satellite 215-3 and third ground station 230-3.

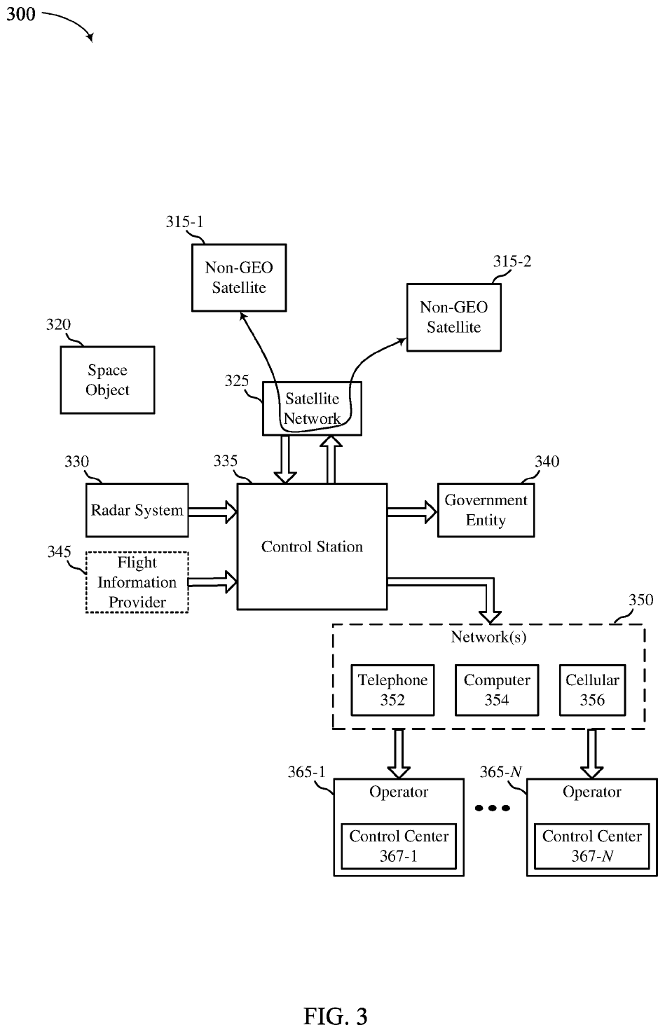

FIG. 3 shows an example of a collision detection system that supports lower orbit satellite tracking in accordance with examples described herein.

Collision detection system 300 shows, in block diagram form, a satellite subsystem including one or more satellite networks and one or more other networks that may interface with the one or more satellite networks in accordance with examples described herein.

Collision detection system 300 includes first non-GEO satellite 315-1, second non-GEO satellite 315-2, space object 320, satellite network 325, radar system 330, control station 335, government entity 340, flight information provider 345, one or more networks 350, and one or more operators 365. First non-GEO satellite 315-1 and second non-GEO satellite 315-2 may be examples of a non-GEO satellite of FIG. 1 or 2. Operators 365 may be an example of operators 265 of FIG. 2.

Space object 320 may be a non-satellite object (e.g., device fragments, meteors, etc.). Space object 320 may also be a satellite (e.g., a non-GEO satellite of FIG. 1 or 2).

Satellite network 325 may be a satellite communications network. Satellite network 325 may include one or more GEO satellites (e.g., GEO satellite 205 of FIG. 2)., one or more ground stations (e.g., first ground station 230-1, second ground station 230-2, and Pth ground station 230-P of FIG. 2), a control center, a network operations center (e.g., network operations center 240 of FIG. 2), terminals (e.g., one or more user terminals 250 of FIG. 2, terminals installed on non-GEO satellites 215 of FIG. 2), or any combination thereof. In some examples, satellite network 325 may also include one or more non-GEO satellites (e.g., first non-GEO satellite 215-1 and Mth non-GEO satellite 215-M, and, in some examples, one or both of first non-GEO satellite 215-1 and second non-GEO satellite 215-2). The non-GEO satellites included in satellite network 325 may serve a variety of roles within satellite network 325 including providing communication services to user terminals 250 (e.g., via GEO satellite 205). In some cases, collection of positioning information from other non-GEO satellites in the satellite network 325 or in other satellite networks may be performed independent of non-GEO satellites in the satellite network 325 (e.g., positioning information may be routed directly through GEO satellite 205 without being routed through non-GEO satellites of satellite network 325).

Radar system 330 may include a network of ground-based radar stations (e.g., a radar station 260 of FIG. 2) used to detect a position of space objects (including space object 320, first non-GEO satellite 315-1, and second non-GEO satellite 315-2).

Flight information provider 345 may provide aeronautical information, such as airspace restrictions, orbital restrictions, weather information, or any combination thereof. The flight information provider 345 may be coupled with ground stations and radar (e.g., radar system 330) that is used to gather the information.

Control station 335 may be configured to detect near-misses and potential collisions between space objects. Control station 335 may be further configured to predict trajectories of the space objects based on positioning information received from satellite network 325, and, in some examples, radar system 330. In some examples, combining the positioning information received from satellite network 325 with positioning information obtained from radar system 330 may increase an accuracy with which a position, trajectory, or both, of a space object is determined. Also, the information obtained from radar system 330 may include positioning information, trajectory information, or both for non-satellite space objects, or satellites that do not transmit positioning information. Control station 335 may use the information obtained from radar system 330 to predict trajectories of non-satellite based objects. In some cases, a trajectory for a satellite may be estimated taking into account the probability distribution of positioning information received from satellite network 325 and positioning information obtained from radar system 330. For example, prior positions for the satellite may be determined from positioning information having a greatest accuracy (e.g., where radar system 330 may have greater accuracy for some positions of the satellite while positioning information from the satellite received via satellite network 325 for other positions of the satellite). Additionally or alternatively, the probability distributions for positioning information received from satellite network 325 and positioning information obtained from radar system 330 may be combined to determine a joint probability distribution.

Control station 335 may also be configured to compare estimated trajectories against one another to detect near-misses and potential collisions between space objects. In some examples, control station 335 may use the information received from radar system 330 to detect near-misses and potential collisions between non-GEO satellites and non-satellite space objects. In some examples, control station 335 may determine evasive actions for one or more of the space objects. In some examples, aspects (or all of) of control station 335 (or a similarly configured component) may be included in satellite network 325—e.g., aspects of control station 335 used to predict trajectories, detect near-misses, determine evasive action, or any combination thereof, may be included in satellite network 325. In some examples, in addition to detecting near-misses and potential collisions between space objects, control station 335 may be used to detect near-misses and potential collisions between air objects.

In some examples, control station 335 alerts government entity 340 of an impending near-miss or collision between space objects—e.g., via one or more networks 350. Network 350 may include telephone network 352, computer network 354, cellular network 356, or a combination thereof. Computer network 354 may include wired (e.g., coaxial cable, conductive wires, fiber-optic wire) and wireless links that are connected to data centers and/or computer networks.

Control station 335 may also indicate suggested evasive action for the space objects. The government entity 340 may be or include the FAA, an agency designated for managing space resources, or both. Additionally, or alternatively, control station 335 may alert one or more operators 365 of an impending near-miss or collision for one or more space objects owned by the one or more operators 365 by sending the alert to one or more control centers 367 of the one or more operators 365.

In some examples, control station 335 detects a near-miss or collision event for first non-GEO satellite 315-1 and second non-GEO satellite 315-2—e.g., based on comparing a predicted trajectory of first non-GEO satellite 315-1 and second non-GEO satellite 315-2. Based on detecting the event, control station 335 may send an alert to an operator of first non-GEO satellite 315-1 and an operator of second non-GEO satellite 315-2 information the operators that their respective non-GEO satellites are at risk of colliding. In some examples, control station 335 also sends suggested evasive action (e.g., a change in altitude or inclination) for the non-GEO satellites to avoid a collision. To determine the suggested evasive action, control station 335 may consider trajectories predicted for additional non-GEO satellites, a service area of the non-GEO satellites, or both.

Based on receiving the alert, the operators 365 may take action to prevent a collision. In some examples, one or both of the operators 365 sends commands to a respective non-GEO satellite to alter its course—e.g., using satellite network 325 or different networks used by the operators.

In some examples, satellite network 325 may be used to route communications between first non-GEO satellite 315-1 and second non-GEO satellite 315-2—e.g., based on first non-GEO satellite 315-1 and second non-GEO satellite 315-2 coming within a threshold distance of one another. In some examples, the communications include positioning data. In some examples, an impending collision between one or both of first non-GEO satellite 315-1 or second non-GEO satellite 315-2 may be detected (e.g., by control station 335, first non-GEO satellite 315-1, or second non-GEO satellite 315-2). In such examples, evasive action may be sent to first non-GEO satellite 315-1 and second non-GEO satellite 315-2, where one or both of first non-GEO satellite 315-1 and second non-GEO satellite 315-2 may automatically take the suggested evasive action. In some example, a non-GEO satellite that takes evasive action may inform (via satellite network 325) the other non-GEO satellite of the evasive action taken so the other non-GEO satellite can maintain its course or take complementary evasive action.

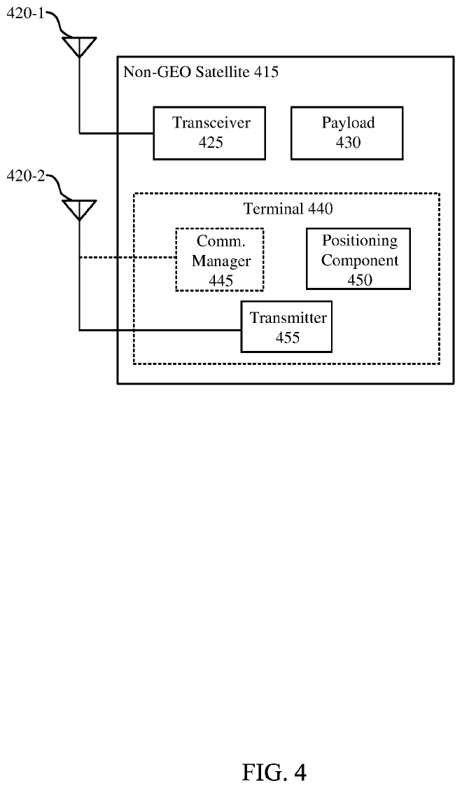

FIG. 4 shows an example of a non-GEO satellite that supports lower orbit satellite tracking in accordance with examples described herein.

Non-GEO satellite 415 may be an example of a non-GEO satellite of FIG. 1, 2, or 3. Non-GEO satellite 415 may be a communications satellite, an imaging satellite, a global positioning satellite, a surveillance satellite, or a combination thereof. In some examples, the function of a satellite may be referred to as an objective for example, an objective of a communications satellite may be communications.

Payload 430 may be configured to support the object of non-GEO satellite 415. For example, if non-GEO satellite 415 is an imaging satellite (e.g., similar to third non-GEO satellite 215-3), payload 430 may include imaging equipment, such as a lens, image sensor, aperture, etc. In another example, non-GEO satellite 415 is a communications satellite (e.g., similar to first non-GEO satellite 215-1, third non-GEO satellite 215-3, or Mth non-GEO satellite 215-M of FIG. 2), and payload 430 may include an antenna array, one or more transponders, etc.

Non-GEO satellite may also include transceiver 425 which may be used to support the operation of payload 430. In some examples, transceiver 425 is configured to receive and transmit communications using time and frequency resources allocated to an operator of non-GEO satellite 415, protocols associated with the operator, etc. Transceiver 425 may be coupled with first antenna 420-1, which may be configured for a first frequency band.

In some examples, terminal 440 may be coupled with (e.g., installed on) non-GEO satellite 415. Terminal 440 may include positioning component 450 and transmitter 455. Positioning component 450 may be used to track a position (e.g., global positioning system (GPS) coordinates), position-related information (e.g., velocity, inclination, altitude, etc.), or both for non-GEO satellite 415. Transmitter 455 may be used to transmit the positioning information generated by positioning component 450. In some examples, positioning component 450 is configured to periodically generate positioning information (e.g., every second), and transmitter 455 is configured to periodically transmit the positioning information generated by positioning component 450. Transmitter 455 may be configured to transmit the positioning information over a periodic set of time and frequency resources in a frequency band that is associated with a network of GEO satellites. In some examples, communications manager 445 generates messages that include sets of the generated positioning information and uses transmitter 455 to periodically transmit the generated messages.

In some examples, terminal 440 may have a subscription to a satellite communications network (e.g., satellite network 325 of FIG. 3). The subscription to the satellite communications network may be a low data rate subscription configured to support the communication of control information that supports satellite communication, information for controlling mobility functions of the satellite, and positioning data—e.g., that supports data rates that are lower than 1 Mbit/second. In such cases, communications manager 445 may be configured to interface with the satellite communications network (e.g., process control information, identify allocated resources, etc.). Also, transmitter 455 may also include a receiver (e.g., transmitter 455 may be or be a part of a transceiver). In some cases, terminal 440 may be independent of payload 430 and transceiver 425. That is, terminal 440 may be isolated from payload 430 and transceiver 425, and may operate independently of payload 430 (independent of the objective of non-GEO satellite 415). For example, an objective of payload 430 may be configured to obtain surveillance imagery, while terminal 440 may not be used for communicating, or have access to, the surveillance imagery—that is, a function of terminal 440 may be limited to identifying communication resources for the transmission of positioning data.

When terminal 440 is a part of a satellite communications network, terminal 440 may be similar to a user terminal, such as a user terminal 250 of FIG. 2. In some examples, a satellite communications network uses different handover techniques to support handing over terminals (such as terminal 440) between satellite beams, GEO satellites, ground stations, or combinations thereof, than the handover techniques used to support handing over user terminals between satellite beams, GEO satellites, ground stations, or combinations thereof—e.g., due to the increased velocity of terminals, such as terminal 440. In some examples, the satellite communications network may initiate handover procedures based on different thresholds for comparing communication parameters or location relative to beam coverage areas. For example, a beam signal power threshold for handover of terminals on non-GEO satellites may be higher—e.g., because the beam signal power may change more quickly for terminals on non-GEO satellites, such as terminal 440. In some examples, the satellite communications network may initiate handover procedures based on a position of terminals, such as terminal 440, because, unlike other terminals, a trajectory of terminal 440 may be known with relative certainty. In some examples, the handover procedure is initiated when terminal 440 comes within a threshold distance of an edge of a beam. In some examples, the threshold distance applied for handover of terminals 440 on non-GEO satellites may be larger than a threshold distance applied to other mobile terminals (terminals on mobile vehicles not in space). The threshold distance may be larger for terminals on non-GEO satellites because they have a higher velocity and a predictable orbit (e.g., will not generally change direction). In some examples, the trajectory information calculated for terminal 440 for near-miss/potential collision detection operations may be used to assist handover determinations—e.g., to determine which beam terminal 440 will enter and a transition time for the beam handover.

Terminal 440 may be coupled with second antenna 420-2. In some examples, second antenna 420-2 may be configured for a frequency band associated with a network of GEO satellites. Second antenna 420-2 may be configured for a same or different frequency band than first antenna 420-1.

In some examples (e.g., when non-GEO satellite is a communications satellite), communications manager 445 may interface with a communication manager included in payload 430. In such cases, the communication manager in payload 430 may be configured to multiplex satellite communications with positioning data generated for non-GEO satellite 415, and, in some examples, the communication manager in payload 430 may transmit the communication data and positioning data using first antenna 420-1 (in such cases, second antenna 420-2 may be omitted). Or communications manager 445 and the communication manager in payload 430 may work in combination to send the communication data and positioning data over multiplexed communication resources (in such cases, the communication managers may share first antenna 420-1, and second antenna 420-2 may be omitted). In other examples, communications manager 445 may transmit the positioning data independent from the communication manager in payload 430 (e.g., by using different frequency bands and different antennas).

In some examples, non-GEO satellite 415 may be a communications satellite that may also support communications within a frequency band used by terminal 440. In such cases, terminal 440 may not include communications manager 445, and transmitter 455 may periodically transmits positioning data over a set of time and frequency resources in a frequency band that is also used for communications by payload 430. In such examples, a communications manager in payload 430 may accommodate the periodic transmissions from transmitter 455 by refraining from transmitting communication data using the set of time and frequency resources used by transmitter 455.

In some examples, transceiver 425, payload 430, communications manager 445, transmitter 455, positioning component 450, or various combinations or components thereof, may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, transceiver 425, payload 430, communications manager 445, transmitter 455, positioning component 450, or various combinations or components thereof, may be implemented in code (e.g., as communications management software or firmware), executed by a processor. If implemented in code executed by a processor, the functions of transceiver 425, payload 430, communications manager 445, transmitter 455, positioning component 450, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

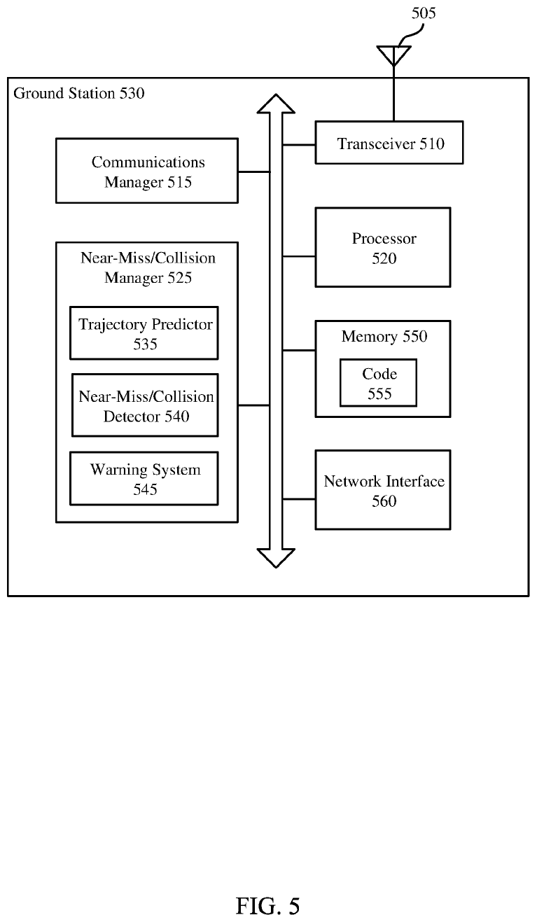

FIG. 5 shows an example of a ground station that supports lower orbit satellite tracking in accordance with examples described herein.

Ground station 530 may be an example of or include the components of a ground station 230 as described with reference to FIG. 2. Ground station 530 may include component for bi-directional communications, including components for transmitting and receiving components and for processing data received in communications. Ground station 530 may include antenna 505, transceiver 510, communications manager 515, processor 520, near-miss/collision manager 525, memory 550, and network interface 560.

Antenna 505 may be configured to receive or transmit information from or to satellites using radio frequency (RF) signals. Antenna 505 may include a parabolic antenna. To receive signals, antenna 505 may reflect received signals to a focal point where an antenna feed passes the signals to a receive chain. To transmit signals, antenna 505 may reflect signals originating from the antenna feed at the focal point.

Transceiver 510 may communicate bi-directionally with another wireless transceiver. The transceiver 510 may also include a modem to modulate signals and provide the modulated signals to antenna 505. The modem may also demodulate signals received from antenna 505. The transceiver 510 and antenna 505 may be an example of a receiver, a transmitter, or both.

Processor 520 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 520 may be configured to operate a memory array using a memory controller. In some other cases, a memory controller may be integrated into the processor 520. The processor 520 may be configured to execute computer-readable instructions stored in a memory (e.g., memory 550) to cause the ground station 530 to perform various functions (e.g., functions or tasks supporting communication for collision detection/warning). For example, the ground station 530 or a component of the ground station 530 may include a processor 520 and memory 550 coupled to the processor 520 that are configured to perform various functions described herein.

The memory 550 may include random access memory (RAM) and read-only memory (ROM). The memory 550 may store code that is computer-readable and computer-executable. The code may include instructions that, when executed by the processor 520, cause the ground station 530 to perform various functions described herein. The code 555 may be stored in a non-transitory computer-readable medium such as system memory or another type of memory. In some cases, the code 555 may not be directly executable by the processor 520 but may cause a computer (e.g., when compiled and executed) to perform functions described herein. In some cases, the memory 550 may contain, among other things, a basic I/O system (BIOS) which may control basic hardware or software operation such as the interaction with peripheral components or devices.

Communications manager 515 may support satellite communications. In some examples, communications manager 515 is used to form beams that span a coverage area. Communications manager 515 may also be used to handle mobility events, such as handing over a user terminal between satellite beams, satellites or handing over non-GEO satellites between GEO satellites. Communications manager 515 may also be used to schedule communications resources for different devices, generate data messages in accordance with a satellite protocol, and map symbols to communication resources.

In some examples, the communications manager 515 may be configured to perform various operations (e.g., receiving, monitoring, transmitting) using or otherwise in cooperation with transceiver 510, antenna 505, or any combination thereof. Although the communications manager 515 is illustrated as a separate component, in some examples, one or more functions described with reference to the communications manager 515 may be supported by or performed by processor 520, memory 550, code 555, or any combination thereof. For example, code 555 may include instructions executable by the processor 520 to cause the ground station 530 to perform various aspects of lens communication with multiple antenna arrays as described herein, or processor 520 and memory 550 may be otherwise configured to perform or support such operations.

Network interface 560 may be configured to send and receive information to other networks (e.g., the Internet, cellular networks, telephone networks, private networks, government networks, etc.). Network interface 560 may translate messages from one protocol to another protocol (e.g., a satellite-based protocol to an Internet protocol).

Near-miss/collision manager 525 may be configured to process positioning data received from non-GEO satellites. In some examples, near-miss/collision manager 525 receives the positioning data for the non-GEO satellites from communications manager 515, which may receive the positioning data in communications received from the non-GEO satellites (e.g., terminals installed on the non-GEO satellites). Near-miss/collision manager 525 may also be used to predict trajectories of the non-GEO satellites, detect near-misses and potential collisions between non-GEO satellites based on the predicted trajectories, and to warn operators of at-risk non-GEO satellites. Near-miss/collision manager 525 may include trajectory predictor 535, near-miss/collision detector 540, and warning system 545.

Trajectory predictor 535 may be configured to predict trajectories (or orbits) for non-GEO satellites—e.g., based on positioning data received from the non-GEO satellites. In some examples, trajectory predictor 535 may continuously update the trajectories of the non-GEO satellites—e.g., each time new positioning data is received.

Near-miss/collision detector 540 may be configured to detect near misses between non-GEO satellites—e.g., to detect if any non-GEO satellites are predicted to come within a threshold distance of another non-GEO satellite. Near-miss/collision detector 540 may also be configured to detect potential collisions between non-GEO satellites. Near-miss/collision detector 540 may detect near-misses and potential collisions by comparing the trajectories of the non-GEO satellites with one another and determining, over a set of upcoming time periods (e.g., every minute of a future five-hour period), whether any of the non-GEO satellites are predicted to come within a threshold distance of one another.

Warning system 545 may be configured to warn operators of non-GEO satellites that have been associated with a near-miss or potential collision event. Warning system 545 may send a notification to the operators of the non-GEO satellites. In some examples, warning system 545 may use network interface 560 to send a warning to the operators of the non-GEO satellites. In some examples, network interface 560 may be configured to provide a warning message received from warning system 545 to a telephone network (e.g., as a robocall), the Internet, a private network, or a government network (e.g., as an email or a notification configured in accordance with an application programming interface for a program used at satellite control centers). In some examples, the private network is a network controlled by a satellite operator, and the government network is a network operated by NORAD.

In some examples, communications manager 515, transceiver 510, near-miss/collision manager 525, or various combinations or components thereof, may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, communications manager 515, transceiver 510, near-miss/collision manager 525, or various combinations or components thereof, may be implemented in code 555 (e.g., as communications management software or firmware), executed by processor 520. If implemented in code 555 executed by processor 520, the functions of communications manager 515, transceiver 510, near-miss/collision manager 525, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

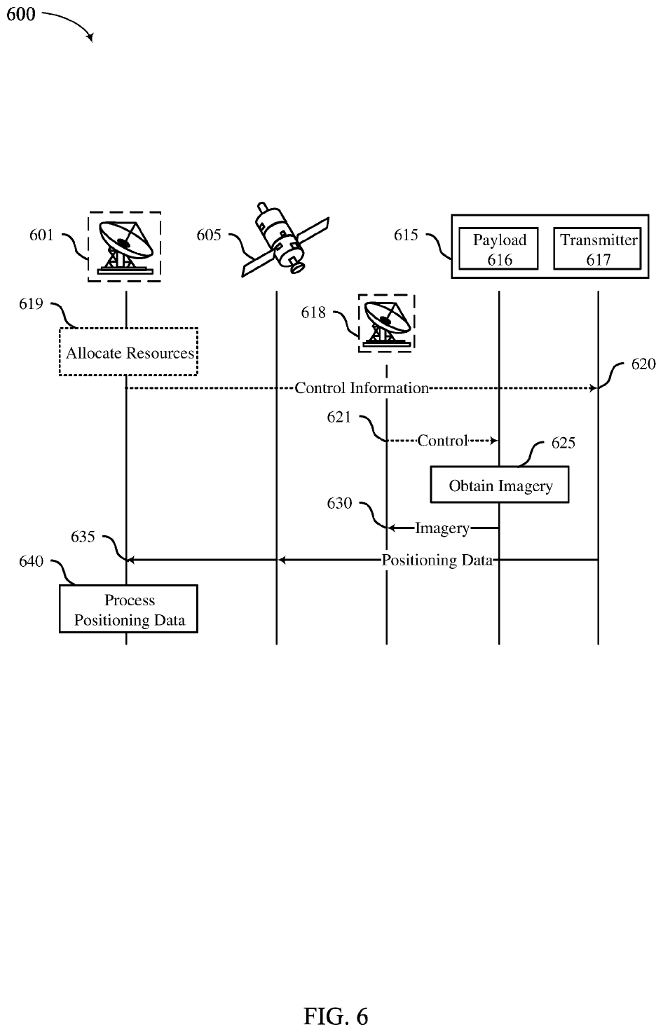

FIG. 6 shows an example of a set of operations for lower orbit satellite tracking in accordance with examples described herein.

Process flow 600 may be performed by first ground station 601, GEO satellite 605, and non-GEO satellite 615, which may be respective examples of a ground station, GEO satellite, and non-GEO satellite described with reference to FIGS. 1 through 5.

In some examples, process flow 600 illustrates an exemplary sequence of operations performed to support lower orbit satellite tracking. For example, process flow 600 depicts operations for a non-GEO satellite (configured for a function other than communications, e.g., imagery, surveillance, global positioning, etc.) to indicate a position to a ground station via a GEO satellite.

It is understood that one or more of the operations described in process flow 600 may be performed earlier or later in the process, omitted, replaced, supplemented, or combined with another operation. Also, additional operations described herein that are not included in process flow 600 may be included.

In some examples, non-GEO satellite 615 has a connection with second ground station 618, which may be an example of a ground station described with reference to FIG. 1. In some examples, non-GEO satellite 615 is an example of fourth non-GEO satellite 215-4 of FIG. 2, and second ground station 618 is an example of third ground station 230-3 of FIG. 2. Non-GEO satellite 615 may include payload 616 and transmitter 617. Payload 616 may be configured to support a function (which may also be referred to as an objective) of non-GEO satellite 615. In some examples, payload 616 is used for surveillance, imagery, global positioning operations of ground or air-based devices, or a combination thereof. Transmitter 617 may be configured to transmit positioning data for non-GEO satellite to GEO satellite 605. In some examples, transmitter 617 may be coupled with a positioning component (e.g., positioning component 450 of FIG. 4). In some examples, transmitter 617 may be included in a terminal (e.g., terminal 440 of FIG. 4) that has a subscription to a satellite communications network that includes first ground station 601 and GEO satellite 605.

At block 619, first ground station 601 (e.g., a network operations center coupled with first ground station 601) may allocate resources for the transmission of positioning data from non-GEO satellites. First ground station 601 may also allocated resources for the transmission of user data from user terminals served by the satellite communications network. In some examples, first ground station 601 allocates resources for positioning data transmissions that are multiplexed (e.g., in time, frequency, or using codes) with resources for user data transmissions. A beam may include the multiplexed resources, and, in some examples, the positioning data and user data resources are multiplexed differently in different beams. In other examples, the positioning data may use common resources across multiple beams. In some examples, the positioning data resources occur periodically. Also, in some examples, sets of positioning data resources are allocated to groups of non-GEO satellites. In some examples, a set of positioning data resources allocated to a non-GEO satellite in a first beam may be different (e.g., use different time resources, frequency resources, or a different code) than another set of positioning data resources allocated to the non-GEO satellite in another beam after a handover procedure is completed. In some cases, first ground station 601 broadcasts different positioning data allocations in different beams.

At arrow 620, first ground station 601 may broadcast control information used to allocate communication resources (e.g., periodic communication resources) to non-GEO satellites in one or more beams. Transmitter 617 (or a terminal that includes transmitter 617) may receive the broadcasted control information and identify a position of communication resources for positioning data transmissions based on the broadcasted control information.

At arrow 621, second ground station 618 may send control information to non-GEO satellite 615. In some examples, the control information includes command information that may be used to change a position, orientation, or both, of non-GEO satellite 615. Additionally, or alternatively, the control information may include control information used to control a functioning of payload 616 of non-GEO satellite 615—e.g., to change a resolution of an image, a region being captured by payload 616, etc.

At block 625, payload 616 of non-GEO satellite 615 may obtain imagery of a geographic region—e.g., based on command data received from second ground station 618. Additionally, or alternatively, payload 616 may determine positioning information for connected devices. In some examples, whether payload 616 obtains imager or positioning information is based on an objective of payload 616 (which may be fixed or configurable).

At arrow 630, payload 616 of non-GEO satellite 615 may transmit the imagery to second ground station 618. Additionally, or alternatively, payload 616 may transmit the positioning information to second ground station 618.

At arrow 635, transmitter 617 of non-GEO satellite 615 may transmit positioning data to GEO satellite 605. In some examples, transmitter 617 transmits the positioning data over resources (e.g., in a frequency band, time resources, frequency resources, or any combination thereof) allocated or reserved for the transmission of positioning data for non-GEO satellites. In some examples, the resources are periodic (e.g., the resources may occur every second), and transmitter 617 periodically transmits over the resources. In some examples, transmitter 617 may transmit the positioning data using the same or a different frequency band than the frequency band used for communications between second ground station 618 and non-GEO satellite 615. In some examples, first ground station 601 broadcasts control information indicating the allocated resources, where transmitter 617 may identify the allocated resources based on receiving the broadcasted control information.

In some examples, transmitter 617 is a part of a transceiver included in a terminal that has a subscription to a satellite communications network that includes first ground station 601 and GEO satellite 605. In some examples, a network operations center of the satellite communications network schedules resources for the terminal to receive communications from the satellite communications network and to transmit communications to the satellite communications network. In some examples, the communications received from the satellite communications network are used to indicate a set of resources (e.g., dynamic or periodic resources) scheduled for the terminal to transmit information to the satellite communications network. Based on receiving an indication of the set of resources, the terminal may use transmitter 617 to transmit positioning data of non-GEO satellite 615 to GEO satellite 605 over the set of resources. In some examples, transmitter 617 may transmit the positioning data using the same or a different frequency band than the frequency band used for communications between second ground station 618 and non-GEO satellite 615.

GEO satellite 605 may relay the positioning data transmitted from non-GEO satellite to first ground station 601. In some examples, GEO satellite 605 relays the positioning data in a signal that includes additional positioning data received from other non-GEO satellites. Additionally, or alternatively, GEO satellite 605 may relay the positioning data in a signal that includes user data received from other non-GEO satellites (e.g., non-GEO satellites configured to support satellite communications).

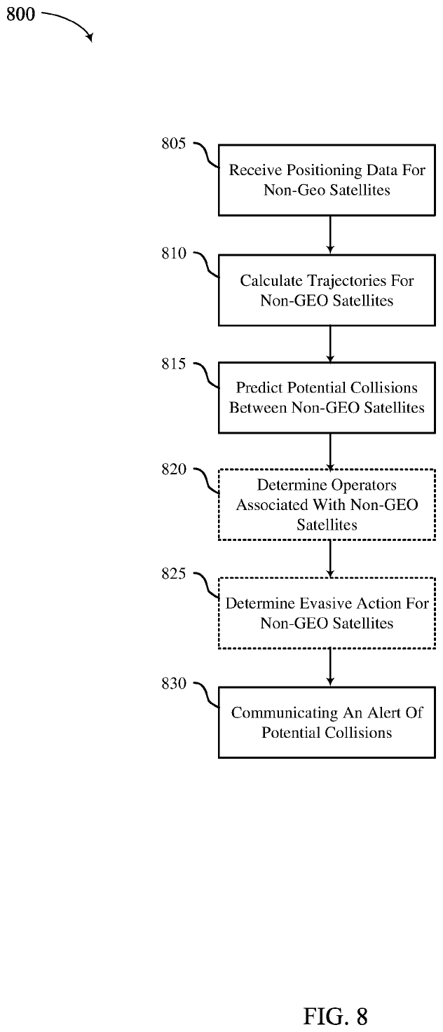

At block 640, first ground station 601 may process the positioning data received from non-GEO satellite, and other non-GEO satellites—e.g., as described herein and with reference to FIG. 8.

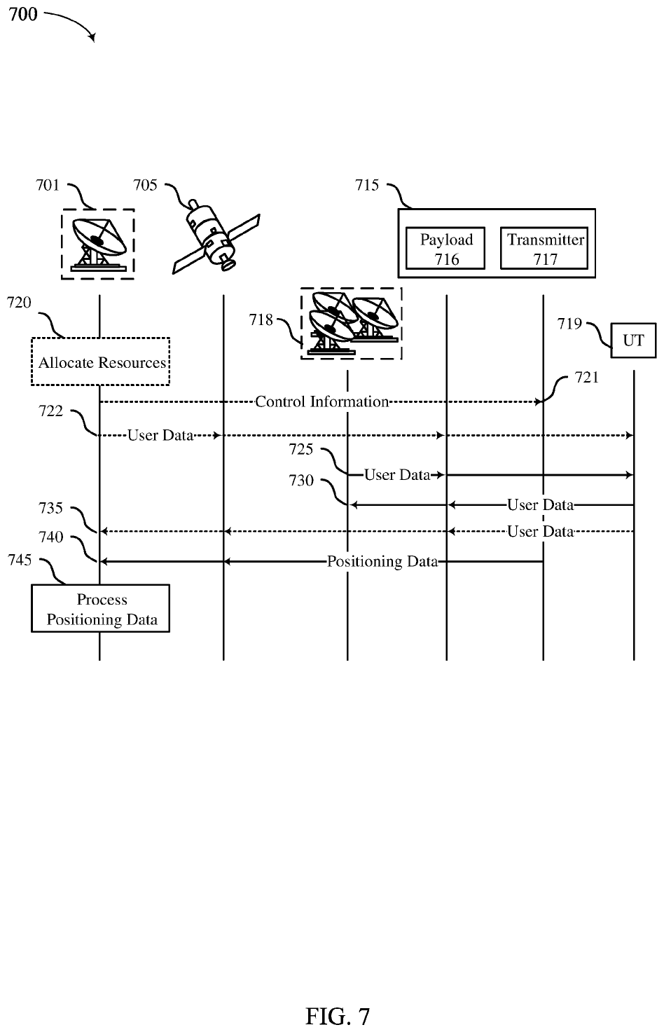

FIG. 7 shows an example of a set of operations for lower orbit satellite tracking in accordance with examples described herein.

Process flow 700 may be performed by first ground station 701, GEO satellite 705, which may be respective examples of a ground station and GEO satellite described with reference to FIGS. 1 through 6. Process flow 700 may also be performed by non-GEO satellite 715, which may be an example of a non-GEO satellite described with reference to FIGS. 1 through 6. In some examples, process flow 700 illustrates an exemplary sequence of operations performed to support lower orbit satellite tracking. For example, process flow 700 depicts operations for a non-GEO satellite configured for communications to indicate a position to a ground station via a GEO satellite.

It is understood that one or more of the operations described in process flow 700 may be performed earlier or later in the process, omitted, replaced, supplemented, or combined with another operation. Also, additional operations described herein that are not included in process flow 700 may be included.

In some examples, non-GEO satellite 715 is a part of a satellite communications network that includes first ground station 701 and GEO satellite 705. In such examples, GEO satellite 705 and non-GEO satellite 715 may be used to relay communications between first ground station 701 and user terminals, such as user terminal 719. In some examples, non-GEO satellite 715 has a direct connection to first ground station 701 or an indirect connection to first ground station 701 via other ground stations, such as ground station network 718. Non-GEO satellite 715 may be an example of first non-GEO satellite 215-1 or Mth non-GEO satellite 215-M of FIG. 2.

At block 720, first ground station 701 may allocate resources for positioning data, user data, or both, as similarly described with reference to block 619 of FIG. 6. At arrow 721, first ground station 701 may broadcast control information including an allocation (e.g., a periodic allocation) of communication resources for positioning data transmissions, as similarly described with reference to arrow 620 of FIG. 6.

At arrow 722, first ground station 701 may transmit network data (e.g., network management signaling, user data signaling, such as voice or data information, etc.) to GEO satellite 705. GEO satellite 705 may relay the user data to non-GEO satellite 715, and payload 716 of non-GEO satellite may relay the user data to user terminal 719.

At arrow 725, ground station network 718 may similarly transmit user data to non-GEO satellite 715, and payload 716 may relay the user data to user terminal 719.

At arrow 730, user terminal 719 may transmit user data to ground station network 718—e.g., based on the user data received from ground station network 718 via payload 716 of non-GEO satellite 715.

At arrow 735, user terminal 719 may transmit user data to first ground station 701 via payload 716 of non-GEO satellite 715 and GEO satellite 705—e.g., based on the user data received from first ground station network 708 via GEO satellite 705 and non-GEO satellite 715. In some examples, user terminal 719 may transmit user data to first ground station 701 via payload 716 when the user data is intended for a device in a distant region on another side of the globe. In some examples, user terminal 719 may be configured to transmit data to only one of first ground station 701 or ground station network 718. In other examples, user terminal 719 may be configured to transmit a first set of user data (e.g., user data destined for locations outside a region) to first ground station 701 and a second set of user data (e.g., user data destined for locations within the region) to ground station network 718. In some examples, user terminal 719 simultaneously transmits the first set of user data and the second set of user data.

In some examples, non-GEO satellite 715 and ground station network 718 are not a part of the satellite communications network that includes first ground station 701 and GEO satellite 705, but are instead a part of a different satellite communications network operated by a different operator than the satellite communications network. In such cases, GEO satellite 705 may be referred to as being in a different constellation than non-GEO satellite 715. Also, the communications transmitted at arrow 722 and arrow 735 may not be performed.

At arrow 740, transmitter 717 of non-GEO satellite 715 may transmit positioning data to GEO satellite 705, as similarly described with reference to arrow 635 of FIG. 6. In some examples, transmitter 617 periodically transmits the positioning data during allocated or reserved resources (e.g., in an allocated or reserved frequency band, allocated or reserved time resources, allocated or reserved frequency resources, or any combination thereof).

In some examples, transmitter 717 is a part of a transceiver included in a terminal that has a subscription to a satellite communications network, as similarly described with reference to arrow 635 of FIG. 6. In some examples, when non-GEO satellite 715 is included in a same satellite communications network as first ground station 701 and GEO satellite 705, the positioning data of non-GEO satellite 715 may be multiplexed with the user data transmitted from payload 716 to GEO satellite 705. For example, the signals generated by transmitter 717 may be combined with the signals generated by payload 716 and transmitted over a same antenna. In other examples, transmitter 717 may transmit the positioning information to GEO satellite 705 separately from the user data transmitted from payload 716—e.g., using a different frequency band, reserved communication resources in a same frequency band, etc.

At block 745, first ground station 601 may process the positioning data received from non-GEO satellite, and other non-GEO satellites—e.g., as described herein and with reference to FIG. 8.

FIG. 8 shows an example of a set of operations for lower orbit satellite tracking in accordance with examples described herein.

Flowchart 800 may be performed by a ground station, a control station, or a combination thereof, which may be examples of a ground station or control station described with reference to FIGS. 2, 3, and 5 through 7. In some examples, flowchart 800 illustrates an exemplary sequence of operations performed to support lower orbit satellite tracking. For example, flowchart 800 depicts operations for detecting and reporting near-misses/potential collisions between lower orbit satellites.

It is understood that one or more of the operations described in flowchart 800 may be performed earlier or later in the process, omitted, replaced, supplemented, or combined with another operation. Also, additional operations described herein that are not included in flowchart 800 may be included.

At block 805, positioning data for multiple non-GEO satellites may be received via a GEO satellite. In some examples, the positioning data may include global positioning coordinates, velocity, altitude, inclination, or any combination thereof. In some examples, the positioning data may be received periodically (e.g., every second). In some examples, the positioning data may be received using reserved resources (e.g., in a reserved frequency band, in reserved time resources, in reserved frequency resources, or any combination thereof).

At block 810, trajectories may be calculated for each of the non-GEO satellites based on the received positioning data. In some examples, the trajectories are calculated based on prior positioning data received for the non-GEO satellites (e.g., based on differences between the sets of positioning data), current positioning data received from the non-GEO satellites (e.g., velocity), or both. In some examples, the trajectories may be recalculated for the non-GEO satellites each time positioning data is received for a non-GEO satellite. If positioning data is not received for a non-GEO satellite, the trajectory may remain unchanged or be updated based on predicted positioning data for the non-GEO satellite.

At block 815, near misses and potential collisions between non-GEO satellites may be predicted based on the calculated trajectories. In some examples, the calculated trajectories may be compared with one another (e.g., superimposed on one another) to determine whether any of the non-GEO satellites will come within a threshold distance of one another at an instant of time. In some examples, near misses, potential collisions, or both may be detected between one or more sets of non-GEO satellites based on the calculated trajectories—e.g., based on determining that a first non-GEO satellite will come within 100 meters of a second non-GEO satellite.

At block 820, operators associated with the one or more sets of non-GEO satellites may be determined. In some examples, all of the non-GEO satellites in a set of non-GEO satellites are determined as being operated by a same operator. In some examples, one of the non-GEO satellites in a set of non-GEO satellites is determined as being operated by a first operator and another of the non-GEO satellites is determined as being operated by a second operator.

At block 825, evasive action may be determined for the one or more sets of non-GEO satellites. In some examples, the evasive action may be for a first non-GEO satellite to alter an inclination by a degree. In some examples, the evasive action may be for a first non-GEO satellite to alter an inclination by a degree in a first direction and the second non-GEO satellite to alter an inclination by a degree in an opposite direction. In some examples, the evasive action is determined based on the calculated trajectories of all or a subset of the non-GEO satellites. For example, the suggested evasive action may be selected so that the evasive action will not cause a near-miss or collision event to occur with a different non-GEO satellite.

At block 830, an alert that the one or more sets of non-GEO satellites have been identified as being at risk of collision may be communicated to respective operators of the non-GEO satellites. In some examples, alerting the respective operators may include triggering a robocall to be sent to both of the operators, an email to be sent to both of the operators, an application-specific notification to be sent to an application running at a control center of the operators, or any combination thereof. Each of the different alerts may include information about the trajectories of the non-GEO satellites that are at risk of collision, suggested evasive action, and the like. In some examples, the alerts may be sent with different levels of priority, with alerts of an imminent collision being a highest priority alert. In some examples, high priority alerts are communicated using all of the available means for communicating the alert, are communicated using more intrusive means (e.g., an application-specific alert), or are communicated to a dedicated endpoint. Low priority alerts may be communicated using less intrusive means, such as an automated email. After receiving an alert, the operators may determine whether to take the suggested evasive action, different action, or no action. When action is taken, the operators may send commands to the respective non-GEO satellites to modify the respective orbits.

In some examples, the alert may be communicated to the non-GEO satellites that are at risk of collision. In such cases, the alert may include the suggested evasive action, which the non-GEO satellites may determine whether to implement. In some examples, if the alert indicates an imminent collision, the non-GEO satellite may automatically implement the suggested evasive action. Additionally, or alternatively, the alert may be communicated to a government entity that tracks the position of objects in space, such as NORAD.

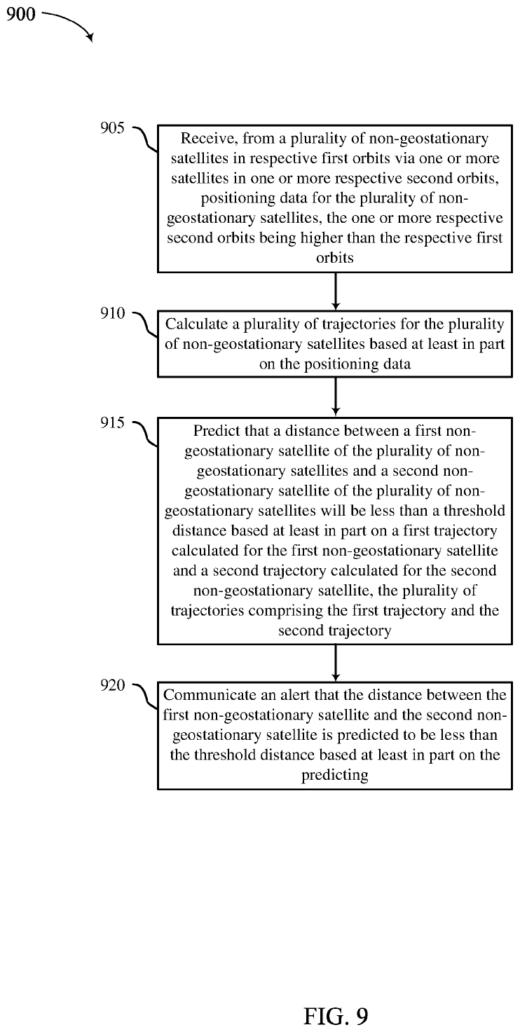

FIG. 9 shows an example of a set of operations for lower orbit satellite tracking in accordance with examples described herein.

Method 900 may be performed by components of a ground station, a control station, or a combination thereof, which may be examples of a ground station or control station described with reference to FIGS. 2, 3, and 5 through 7. In some examples, a ground station or control station may execute a set of instructions to control the functional elements of the ground station or control station to perform the described functions. Additionally, or alternatively, the ground station or control station may perform aspects of the described functions using special-purpose hardware.

At 905, method 900 may include receiving, from a plurality of non-geostationary satellites in respective first orbits via one or more satellites in one or more respective second orbits, positioning data for the plurality of non-geostationary satellites, the one or more respective second orbits being higher than the respective first orbits. The operations of 905 may be performed in accordance with examples as disclosed herein. In some examples, aspects of the operations of 905 may be performed by a transceiver, as described herein and with reference to FIG. 5.

At 910, method 900 may include calculating a plurality of trajectories for the plurality of non-geostationary satellites based at least in part on the positioning data. The operations of 910 may be performed in accordance with examples as disclosed herein. In some examples, aspects of the operations of 910 may be performed by a trajectory predictor, as described as described herein and with reference to FIG. 5.

At 915, method 900 may include predicting that a distance between a first non-geostationary satellite of the plurality of non-geostationary satellites and a second non-geostationary satellite of the plurality of non-geostationary satellites will be less than a threshold distance based at least in part on a first trajectory calculated for the first non-geostationary satellite and a second trajectory calculated for the second non-geostationary satellite, the plurality of trajectories comprising the first trajectory and the second trajectory. The operations of 915 may be performed in accordance with examples as disclosed herein. In some examples, aspects of the operations of 915 may be performed by a near-miss/collision detector, as described as described herein and with reference to FIG. 5.

At 920, method 900 may include communicating an alert that the distance between the first non-geostationary satellite and the second non-geostationary satellite is predicted to be less than the threshold distance based at least in part on the predicting. The operations of 920 may be performed in accordance with examples as disclosed herein. In some examples, aspects of the operations of 920 may be performed by a warning system, as described as described herein and with reference to FIG. 5.

In some examples, an apparatus as described herein may perform a method or methods, such as the method 900. The apparatus may include, features, circuitry, logic, means, or instructions (e.g., a non-transitory computer-readable medium storing instructions executable by a processor) for receiving, from a plurality of non-geostationary satellites in respective first orbits via one or more satellites in one or more respective second orbits, positioning data for the plurality of non-geostationary satellites, the one or more respective second orbits being higher than the respective first orbits, calculating a plurality of trajectories for the plurality of non-geostationary satellites based at least in part on the positioning data, predicting that a distance between a first non-geostationary satellite of the plurality of non-geostationary satellites and a second non-geostationary satellite of the plurality of non-geostationary satellites will be less than a threshold distance based at least in part on a first trajectory calculated for the first non-geostationary satellite and a second trajectory calculated for the second non-geostationary satellite, the plurality of trajectories including the first trajectory and the second trajectory, and communicating an alert that the distance between the first non-geostationary satellite and the second non-geostationary satellite is predicted to be less than the threshold distance based at least in part on the predicting.

Some examples of the method 900 and the apparatus described herein may further include operations, features, circuitry, logic, means, or instructions for receiving, from the one or more satellites, second positioning data for the plurality of non-geostationary satellites and recalculating the plurality of trajectories for the plurality of non-geostationary satellites based at least in part on the second positioning data.

In some examples of the method 900 and the apparatus described herein, receiving the positioning data may include operations, features, circuitry, logic, means, or instructions for receiving, from a first satellite of the one or more satellites during a first duration, a first portion of the positioning data for a first subset of the plurality of non-geostationary satellites and receiving, from a second satellite of the one or more satellites during a second duration, a second portion of the positioning data for a second subset of the plurality of non-geostationary satellites.

In some examples of the method 900 and the apparatus described herein, periodically receiving the positioning data from the plurality of non-geostationary satellites, where a duration between receiving sets of the positioning data from each of the plurality of non-geostationary satellites may be less than a threshold duration.

In some examples of the method 900 and the apparatus described herein, the threshold duration may be less than five minutes.

Some examples of the method 900 and the apparatus described herein may further include operations, features, circuitry, logic, means, or instructions for establishing respective communication links with a plurality of transmitters that may be coupled with respective non-geostationary satellites of the plurality of non-geostationary satellites, where receiving the positioning data may be based at least in part on establishing the respective communication links.

Some examples of the method 900 and the apparatus described herein may further include operations, features, circuitry, logic, means, or instructions for allocating a first set of communication resources of a satellite beam of the one or more satellites to a plurality of terminals including the plurality of transmitters and a second set of communication resources of the satellite beam to a plurality of user terminals based at least in part on establishing the respective communication links with the plurality of terminals and receiving user data from the plurality of user terminals over the first set of communication resources and the positioning data from the plurality of terminals over the second set of communication resources.

In some examples of the method 900 and the apparatus described herein, a first constellation includes the one or more satellites and a second constellation includes at least a subset of the plurality of non-geostationary satellites.

In some examples of the method 900 and the apparatus described herein, a first satellite network operated by a first operator includes the ground station and the one or more satellites, and a second satellite network operated by a second operator includes a subset of the plurality of non-geostationary satellites.

Some examples of the method 900 and the apparatus described herein may further include operations, features, circuitry, logic, means, or instructions for communicating a subscription to use the first satellite network for a terminal of a non-geostationary satellite of the plurality of non-geostationary satellites to a network operations center of the first satellite network, the terminal including a transmitter of the plurality of transmitters.

Some examples of the method 900 and the apparatus described herein may further include operations, features, circuitry, logic, means, or instructions for determining that the first non-geostationary satellite may be on course to collide with the second non-geostationary satellite based at least in part on predicting that the distance between the first non-geostationary satellite and the second non-geostationary satellite may be less than the threshold distance, where the alert includes an indication of a predicted collision.

In some examples of the method 900 and the apparatus described herein, communicating the alert may include operations, features, circuitry, logic, means, or instructions for contacting a first operator of the first non-geostationary satellite and a second operator of the second non-geostationary satellite using a telephone network, a computer network, or both.

In some examples of the method 900 and the apparatus described herein, contacting the first operator and the second operator using the telephone network may include operations, features, circuitry, logic, means, or instructions for initiating a first automated call to a control center of the first operator and a second automated call to a control center of the second operator.

In some examples of the method 900 and the apparatus described herein, contacting the first operator and the second operator using the computer network may include operations, features, circuitry, logic, means, or instructions for sending a first electronic mail notification to an electronic mail account of the first operator and a second electronic mail notification to an electronic mail account of the second operator and sending a first notification to a program running at a control center of the first operator and a second notification to the program running at a control center of the second operator based at least in part an application programming interface of the program, or both.

In some examples of the method 900 and the apparatus described herein, the alert may include operations, features, circuitry, logic, means, or instructions for an indication that the distance between the first non-geostationary satellite and the second non-geostationary satellite will be below the threshold distance, an indication of a predicted collision between the first non-geostationary satellite and the second non-geostationary satellite, an indication of an evasive action for the first non-geostationary satellite, the second non-geostationary satellite, or both, and any combination thereof.

Some examples of the method 900 and the apparatus described herein may further include operations, features, circuitry, logic, means, or instructions for performing first handoffs of user terminals on non-space-based vehicles between satellite beams of the one or more satellites according to a first set of parameters associated with the non-space-based vehicles and performing second handoffs of terminals on the plurality of non-geostationary satellites between the satellite beams of the one or more satellites according to a second set of parameters associated with the plurality of non-geostationary satellites.

Some examples of the method 900 and the apparatus described herein may further include operations, features, circuitry, logic, means, or instructions for determining an evasive action for at least one of the first non-geostationary satellite or the second non-geostationary satellite based at least in part on the plurality of trajectories, where the alert includes an indication of the evasive action.

Some examples of the method 900 and the apparatus described herein may further include operations, features, circuitry, logic, means, or instructions for calculating one or more first potential trajectories for the first non-geostationary satellite based at least in part on one or more first potential corrections by the first non-geostationary satellite and calculating one or more second potential trajectories for the second non-geostationary satellite based at least in part on one or more second potential corrections by the second non-geostationary satellite, where the evasive action may be determined based at least in part on the one or more first potential trajectories, the one or more second potential trajectories, or both.

Some examples of the method 900 and the apparatus described herein may further include operations, features, circuitry, logic, means, or instructions for using radio detection and ranging techniques to determine second positioning data for the plurality of non-geostationary satellites, where the plurality of trajectories may be further calculated based at least in part on the second positioning data.

In some examples of the method 900 and the apparatus described herein, the plurality of non-geostationary satellites may be low earth orbit satellites and the first orbits may be low earth orbits, and the one or more satellites may be geostationary satellites and the one or more respective second orbits may be geostationary orbits.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for satellite operations at a ground station, comprising:
receiving, from a plurality of non-geostationary satellites in respective first orbits via one or more satellites in one or more respective second orbits, positioning data for the plurality of non-geostationary satellites, the one or more respective second orbits being higher than the respective first orbits;
calculating a plurality of trajectories for the plurality of non-geostationary satellites based at least in part on the positioning data;
predicting that a distance between a first non-geostationary satellite of the plurality of non-geostationary satellites and a second non-geostationary satellite of the plurality of non-geostationary satellites will be less than a threshold distance based at least in part on a first trajectory calculated for the first non-geostationary satellite and a second trajectory calculated for the second non-geostationary satellite, the plurality of trajectories comprising the first trajectory and the second trajectory; and
communicating an alert that the distance between the first non-geostationary satellite and the second non-geostationary satellite is predicted to be less than the threshold distance based at least in part on the predicting.

2. The method of claim 1, further comprising:
receiving, from the one or more satellites, second positioning data for the plurality of non-geostationary satellites; and
recalculating the plurality of trajectories for the plurality of non-geostationary satellites based at least in part on the second positioning data.

3. The method of claim 1, wherein receiving the positioning data comprises:
receiving, from a first satellite of the one or more satellites during a first duration, a first portion of the positioning data for a first subset of the plurality of non-geostationary satellites; and
receiving, from a second satellite of the one or more satellites during a second duration, a second portion of the positioning data for a second subset of the plurality of non-geostationary satellites.

4. The method of claim 1, further comprising:
periodically receiving the positioning data from the plurality of non-geostationary satellites, wherein a duration between receiving sets of the positioning data from each of the plurality of non-geostationary satellites is less than a threshold duration.

5. The method of claim 4, wherein the threshold duration is less than five minutes.

6. The method of claim 1, further comprising:
establishing respective communication links with a plurality of transmitters that are coupled with respective non-geostationary satellites of the plurality of non-geostationary satellites, wherein receiving the positioning data is based at least in part on establishing the respective communication links.

7. The method of claim 6, further comprising:
allocating a first set of communication resources of a satellite beam of the one or more satellites to a plurality of terminals comprising the plurality of transmitters and a second set of communication resources of the satellite beam to a plurality of user terminals based at least in part on establishing the respective communication links with the plurality of terminals; and
receiving user data from the plurality of user terminals over the first set of communication resources and the positioning data from the plurality of terminals over the second set of communication resources.

8. The method of claim 6, wherein a first constellation comprises the one or more satellites and a second constellation comprises at least a subset of the plurality of non-geostationary satellites.

9. The method of claim 6, wherein a first satellite network operated by a first operator comprises the ground station and the one or more satellites, and wherein a second satellite network operated by a second operator comprises a subset of the plurality of non-geostationary satellites.

10. The method of claim 9, further comprising:
communicating a subscription to use the first satellite network for a terminal of a non-geostationary satellite of the plurality of non-geostationary satellites to a network operations center of the first satellite network, the terminal comprising a transmitter of the plurality of transmitters.

11. The method of claim 1, further comprising:
determining that the first non-geostationary satellite is on course to collide with the second non-geostationary satellite based at least in part on predicting that the distance between the first non-geostationary satellite and the second non-geostationary satellite is less than the threshold distance, wherein the alert comprises an indication of a predicted collision.

12. The method of claim 1, wherein communicating the alert comprises:
contacting a first operator of the first non-geostationary satellite and a second operator of the second non-geostationary satellite using a telephone network, a computer network, or both.

13. The method of claim 12, wherein contacting the first operator and the second operator using the telephone network comprises:
initiating a first automated call to a control center of the first operator and a second automated call to a control center of the second operator.

14. The method of claim 12, wherein contacting the first operator and the second operator using the computer network comprises:
sending a first electronic mail notification to an electronic mail account of the first operator and a second electronic mail notification to an electronic mail account of the second operator, and
sending a first notification to a program running at a control center of the first operator and a second notification to the program running at a control center of the second operator based at least in part an application programming interface of the program, or both.

15. The method of claim 1, wherein the alert comprises:
an indication that the distance between the first non-geostationary satellite and the second non-geostationary satellite will be below the threshold distance;
an indication of a predicted collision between the first non-geostationary satellite and the second non-geostationary satellite an indication of an evasive action for the first non-geostationary satellite, the second non-geostationary satellite, or both; or
any combination thereof.

16. The method of any claim 1, further comprising:
performing first handoffs of user terminals on non-space-based vehicles between satellite beams of the one or more satellites according to a first set of parameters associated with the non-space-based vehicles; and
performing second handoffs of terminals on the plurality of non-geostationary satellites between the satellite beams of the one or more satellites according to a second set of parameters associated with the plurality of non-geostationary satellites.

17. The method of claim 1, further comprising:
determining an evasive action for at least one of the first non-geostationary satellite or the second non-geostationary satellite based at least in part on the plurality of trajectories, wherein the alert comprises an indication of the evasive action.

18. The method of claim 17, further comprising:
calculating one or more first potential trajectories for the first non-geostationary satellite based at least in part on one or more first potential corrections by the first non-geostationary satellite; and
calculating one or more second potential trajectories for the second non-geostationary satellite based at least in part on one or more second potential corrections by the second non-geostationary satellite, wherein the evasive action is determined based at least in part on the one or more first potential trajectories, the one or more second potential trajectories, or both.

19. The method of claim 1, further comprising:
using radio detection and ranging techniques to determine second positioning data for the plurality of non-geostationary satellites, wherein the plurality of trajectories is further calculated based at least in part on the second positioning data.

20. The method of claim 1, wherein:
the plurality of non-geostationary satellites are low earth orbit satellites and the respective first orbits are low earth orbits, and
the one or more satellites are geostationary satellites and the one or more respective second orbits are geostationary orbits.

21. An apparatus for satellite operations at a ground station, comprising:
one or more processors;
memory coupled with the one or more processors; and
instructions stored in the memory and executable by the one or more processors to:
receive, from a plurality of non-geostationary satellites in respective first orbits via one or more satellites in one or more respective second orbits, positioning data for the plurality of non-geostationary satellites, the one or more respective second orbits being higher than the respective first orbits;
calculate a plurality of trajectories for the plurality of non-geostationary satellites based at least in part on the positioning data;
predict that a distance between a first non-geostationary satellite of the plurality of non-geostationary satellites and a second non-geostationary satellite of the plurality of non-geostationary satellites will be less than a threshold distance based at least in part on a first trajectory calculated for the first non-geostationary satellite and a second trajectory calculated for the second non-geostationary satellite, the plurality of trajectories comprising the first trajectory and the second trajectory; and
communicate an alert that the distance between the first non-geostationary satellite and the second non-geostationary satellite is predicted to be less than the threshold distance based at least in part on the predicting.

22. The apparatus of claim 21, wherein the instructions are further executable by the one or more processors to:
receive, from the one or more satellites, second positioning data for the plurality of non-geostationary satellites; and
recalculate the plurality of trajectories for the plurality of non-geostationary satellites based at least in part on the second positioning data.

23. The apparatus of claim 21, wherein the instructions to receive the positioning data are further executable by the one or more processors to:
receive, from a first satellite of the one or more satellites during a first duration, a first portion of the positioning data for a first subset of the plurality of non-geostationary satellites; and
receive, from a second satellite of the one or more satellites during a second duration, a second portion of the positioning data for a second subset of the plurality of non-geostationary satellites.

24. The apparatus of claim 21, wherein the instructions are further executable by the one or more processors to:
periodically receive the positioning data from the plurality of non-geostationary satellites, wherein a duration between receiving sets of the positioning data from each of the plurality of non-geostationary satellites is less than a threshold duration.

25. The apparatus of claim 21, wherein the instructions are further executable by the one or more processors to:
establish respective communication links with a plurality of transmitters that are coupled with respective non-geostationary satellites of the plurality of non-geostationary satellites, wherein receiving the positioning data is based at least in part on establishing the respective communication links.

26. The apparatus of claim 21, wherein the instructions are further executable by the one or more processors to:
determine that the first non-geostationary satellite is on course to collide with the second non-geostationary satellite based at least in part on predicting that the distance between the first non-geostationary satellite and the second non-geostationary satellite is less than the threshold distance, wherein the alert comprises an indication of a predicted collision.

27. The apparatus of claim 21, wherein the instructions to communicate the alert are further executable by the one or more processors to:
contact a first operator of the first non-geostationary satellite and a second operator of the second non-geostationary satellite using a telephone network, a computer network, or both.

28. The apparatus of claim 21, wherein the instructions are further executable by the one or more processors to:
perform first handoffs of user terminals on non-space-based vehicles between satellite beams of the one or more satellites according to a first set of parameters associated with the non-space-based vehicles; and
perform second handoffs of terminals on the plurality of non-geostationary satellites between the satellite beams of the one or more satellites according to a second set of parameters associated with the plurality of non-geostationary satellites.

29. The apparatus of claim 21, wherein the instructions are further executable by the one or more processors to:
determine an evasive action for at least one of the first non-geostationary satellite or the second non-geostationary satellite based at least in part on the plurality of trajectories, wherein the alert comprises an indication of the evasive action.

30. The apparatus of claim 21, wherein the instructions are further executable by the one or more processors to:
use radio detection and ranging techniques to determine second positioning data for the plurality of non-geostationary satellites, wherein the plurality of trajectories is further calculated based at least in part on the second positioning data.
